(19) United States
(12) Patent Application Publication
(10) Pub. No.: US 2013/0086167 A1
(43) Pub. Date: Apr. 4, 2013

(54) METHOD AND APPARATUS FOR IDENTITY EXPRESSION IN DIGITAL MEDIA

(71) Applicant: Jan Otto BLOM, Lutry (CH)

(72) Inventor: Jan Otto BLOM, Lutry (CH)

(73) Assignee: Nokia Corporation, Espoo (FI)

(21) Appl. No.: 13/621,985

(22) Filed: Sep. 18, 2012

Related U.S. Application Data
(60) Provisional application No. 61/541,524, filed on Sep. 30, 2011.

(51) Int. Cl. G06F 15/16

(52) U.S. Cl. 709/204

(57) ABSTRACT

An approach is provided for identity expression in digital media. A user identity platform processes and/or facilitates a processing of contextual data associated with a user, one or more devices associated with the user, or a combination thereof to determine one more or user personality characteristics. The user identity platform then causes, at least in part, a generation of one or more identity tokens based, at least in part, on the one or more user personality characteristics. In one embodiment, the one or more identity tokens represent the user in one or more services, one or more applications, or a combination thereof.

### RELATED APPLICATIONS

This application claims benefit of the earlier filing date under 35 U.S.C. §119(e) of U.S. Provisional Application Ser. No. 61/541,524 filed Sep. 30, 2011, entitled “Method and Apparatus for Identity Expression in Digital Media,” the entirety of which is incorporated herein by reference.

### BACKGROUND

Service providers and device manufacturers (e.g., wireless, cellular, etc.) are continually challenged to deliver value and convenience to consumers by, for example, providing compelling network services such as social networking, mobile communication services, and the like. As the popularity and variety of these types of services increase, users are finding an increased need to manage their personal identities when engaged in online-based social interactions. For example, on many social networking services, identity tokens (e.g., pictures, avatars, icons, etc.) are used to represent users with the services. Traditionally, users can either use a default identity token or spend time personalizing the identity token. However, as the number of services and/or applications using such identity tokens increase, users may often find it too burdensome to personalize and/or maintain their identity tokens. Accordingly, service providers and device manufacturers face significant technical challenges to enable efficient identity expression in digital media that can be used as, for instance, identity tokens for services and applications.

### SOME EXAMPLE EMBODIMENTS

Therefore, there is a need for an approach for facilitating and reducing user burden for creating and/or otherwise maintaining identity tokens for personalizing identity expression.

According to one embodiment, a method comprises processing and/or facilitating a processing of contextual data associated with a user, one or more devices associated with the user, or a combination thereof to determine one more or user personality characteristics. The method also comprises causing, at least in part, a generation of one or more identity tokens based, at least in part, on the one or more user personality characteristics. In one embodiment, the one or more identity tokens represent the user in one or more services, one or more applications, or a combination thereof.

According to another embodiment, an apparatus comprises at least one processor, and at least one memory including computer program code for one or more programs, the at least one memory and the computer program code configured to, with the at least one processor, cause, at least in part, the apparatus to process and/or facilitate a processing of contextual data associated with a user, one or more devices associated with the user, or a combination thereof to determine one more or user personality characteristics. The apparatus also causes, at least in part, a generation of one or more identity tokens based, at least in part, on the one or more user personality characteristics. In one embodiment, the one or more identity tokens represent the user in one or more services, one or more applications, or a combination thereof.

According to another embodiment, a computer-readable storage medium carries one or more sequences of one or more instructions which, when executed by one or more processors, cause, at least in part, an apparatus to process and/or facilitate a processing of contextual data associated with a user, one or more devices associated with the user, or a combination thereof to determine one more or user personality characteristics. The apparatus also causes, at least in part, a generation of one or more identity tokens based, at least in part, on the one or more user personality characteristics. In one embodiment, the one or more identity tokens represent the user in one or more services, one or more applications, or a combination thereof.

According to another embodiment, an apparatus comprises means for processing and/or facilitating a processing of contextual data associated with a user, one or more devices associated with the user, or a combination thereof to determine one more or user personality characteristics. The apparatus also comprises means for causing, at least in part, a generation of one or more identity tokens based, at least in part, on the one or more user personality characteristics. In one embodiment, the one or more identity tokens represent the user in one or more services, one or more applications, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing identity expression in digital media, according to one embodiment;

FIG. 2 is a diagram of components of a user identity platform, according to one embodiment;

FIG. 3 is a flowchart of a process for providing identity expression in digital media, according to one embodiment;

FIGS. 4A-4D are diagrams of user interfaces used in the processes of FIGS. 1-3, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for providing identity expression in digital media are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are discussed with respect to graphically-based identity tokens (e.g., avatars, icons, images, etc.), it is contemplated that the various embodiments are also applicable to identity tokens based graphics, images, audio, text, badges, multimedia, or any other type of digital media. By way of example, identity tokens can be presented (e.g., displayed, played back, etc.) in any number of services as a representation of the user.

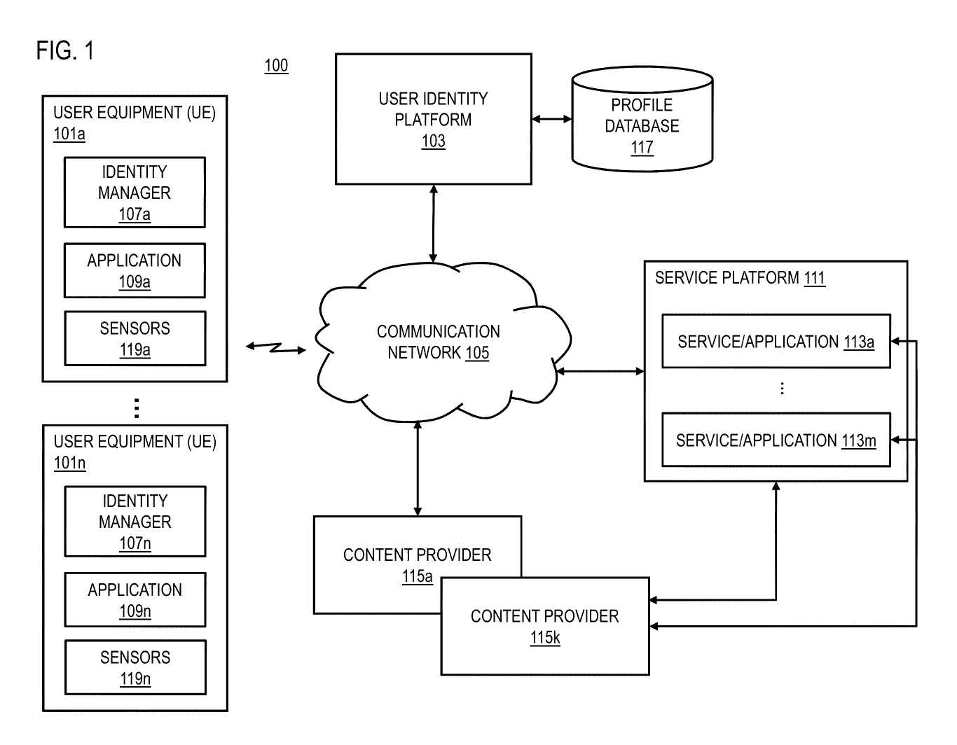

FIG. 1 is a diagram of a system capable of selecting devices to form a community, according to one embodiment. As discussed previously, services and applications that provide for identity tokens to represent the personal identities of users when engaged in online interactions are becoming increasingly popular. For instance, in a social networking service (e.g., Facebook), pictures chose for a user's profile and comments posted on other users' walls often represent aspects of managing how a user appears or is presented to other users in the service. That is, there often is a strong psychological disposition among users of Internet services and applications to regulate the way each individual appears to other service users. By way of example, the need to express identity can be manifested across several behavioral modalities. For instance, the way people dress up, decorate their personal possessions and homes, etc. are all part of the daily impression management repertoire that any given individual maintains. Viewed in this way, identity expression through digital services is only an extension of strong behavioral characteristics commonly exhibited by most users.

However, the need for identity expression and management can often become overly cumbersome for users, particularly when users engage in multiple services or wish to select identity tokens to reflect behavioral or personality characteristics that can change with the users context or that can evolve over time. Historically, selecting identity tokens for services and/or applications involves manually selecting a representative picture. If the user wants to update the identity token (e.g., to reflect new interests, new behaviors, etc.), the user typically would have to manually reselect new identity tokens to use. Overtime, the burden (e.g., burden associated with tracking which services need identity tokens, generating media for incorporation into such tokens, etc.) can quickly overwhelm many users, thereby discouraging their use of such services.

To address this problem, a system 100 of FIG. 1 supports the user in fulfilling the psychological need of identity expression by automatically constructing one or more identity tokens (e.g., graphical profiles or other representations) which can subsequently be displayed or otherwise used to represent the user when interaction in services and/or applications. In one embodiment, the system 100 constructs or generates the identity tokens based, at least in part, on contextual data collected on user devices. For example, contextual data (e.g., mobility information indicating places visited, durations of those visits, etc.) can be processed to determine behavioral and/or personality characteristics of associated users. In other words, it is contemplated that the contextual data or information extracted from user devices can be used to determine user behavior and/or personality characteristics that are indicative of the identity of the user. In one embodiment, the system 100 processes the determined user behavior or personality characteristics to generate representative identity tokens.

As used in the descriptions of the various embodiments described herein, the contextual data refers, for instance, to data that indicates the state of a device, state of the device environment and/or the inferred state of a user of the device. The states indicated by the context are, for instance, described according to one or more “contextual parameters” including time, recent applications running on the device, recent World Wide Web pages presented on the device, keywords in current communications (such as emails, SMS messages, IM messages), current and recent locations of the device (e.g., from a global positioning system, GPS, or cell tower identifier), environment temperature, ambient light, movement, transportation activity (e.g., driving a car, riding the metro, walking, cycling, etc.), activity (e.g., eating at a restaurant, drinking at a bar, watching a movie at a cinema, watching a video at home or at a friend's house, exercising at a gymnasium, travelling on a business trip, travelling on vacation, etc.), emotional state (e.g., happy, busy, calm, rushed, etc.), interests (e.g., music type, sport played, sports watched), contacts, or contact groupings (e.g., family, friends, colleagues, etc.), among others, or some combination thereof.

In one example use case, a mobile phone of a target user collects contextual data, such as that pertaining to location or proximity-based social interaction of the target user. Using the collected data, the system 100 derives one or more personality characteristics or types. In one embodiment, the personality characteristics can be specified from predetermined categories or can be derived based on the processing. For instance, if location data is accessible to the system 100, inferences can be made about whether the target user is a home person, work person, or party person. The resulting personality characteristics is then converted to an identity token (e.g., a graphical identity token), which can be displayed in a digital media application or service such as social networking services.

In one embodiment, the identity token can evolve over time, based on behavioral or personality changes detected in collected contextual data. By way of example, depending on the preferences of the user, the identity token can be generated to reflect real-time or substantially real-time behavioral or personality characteristics (e.g., a short term time period or scale for collecting contextual data) or at the other extreme, based on long term stable characteristics of the user (e.g., a longer time period for collecting contextual data).

In one embodiment, the system 100 enables unidirectional or bidirectional communication between identity token creation and the services and/or applications using the identity tokens. For example, in one embodiment, on creating an identity token, the system 100 can transmit the identity token to one or more services and/or applications designated by the user without further interaction. In another embodiment, the system 100 may receive feedback from the service and/or application regarding the popularity of a generated identity token. In yet another embodiment, the system 100 may interact with the service or application to determine what data modalities of the contextual data should be processed for a given service or application. For example, a data modality can be a subset of the contextual data such as mobility data, application usage data, search history data, activity data, sensor (e.g., gyroscopes, accelerometers, proximity sensors, etc.) data, and the like. For example, a sports tracking application may be specify data modalities related to physical activity such as mobility data, activity data, sensor data, etc. In this way, the system 100 can determine behavioral or personality characteristics specific to the data modalities of most relevance to a particular service or application.

In one use case, location data may be a data modality of main importance or relevance. For instance, in this use case, a user may activity an identity tracking service on his or her mobile device using a specific application. By activating the service, the user has also consented to automated collection of contextual data. In some embodiments, to adhere to privacy considerations, the contextual data collected by the mobile phone is not uploaded to the server, but instead, as much as possible of the analysis or processing of the sensitive data performed locally at the mobile device.

Once the service has been activated, the identity tracking service or client of the service instructs the mobile phone to start collecting contextual data (e.g., in this case, location data) in a continuous fashion, over data modalities such as GPS, Cell ID, geolocalized WiFi access points, etc. In one embodiment, the continuously collected location data is analyzed to identify locations in which the user spends time. For example, these locations may be designated as location anchors.

In some embodiments, the system 100 may attempt to semantically group the location anchors or otherwise determine a semantic meaning or relationship of the location anchors. The following list provides example techniques for determining semantic meaning:
1. The identity tracking service or client prompts the user to label location anchors as they are determined from the analysis of the raw location data.
2. The geolocations of the location anchors are compared to a point-of-interest (POI) database. This allows classification of location to, e.g., private residence, restaurant, bar, night club, supermarket, fashion store, sports facility, public building, etc.
3. Heuristics can be used to determine which location of the user is the user's home and which one is the user's work place. For the former, continued presence in the given location at night is a reliable indicator. For the latter, continued presence in the given location during typical working hours can be taken as a reliable indicator.

Once the semantics has been derived for as many locations anchors as possible, the personality type of the user can be determined. In one embodiment, the following logic listed in Table 1 can be used:

TABLE 1

| Personality | |
|---|---|
| type | Behavioral indicators or personality characteristics |
| Party animal | High proportion of bars and night clubs in the location |
| | anchor list. Many late night arrivals in one's home. |
| Workaholic | Plenty of time used in the office. |
| Shopaholic | High proportion of fashion and high street shops in one's |
| | location anchor list. |
| Sports freak | High proportion of sports facilities in one's location anchor |
| | list. Accelerometer data gives away that the user does a |
| | lot of outdoor exercises, such as biking, hiking or jogging. |
| Nature lover | The person spends a lot of time outside of the city, |
| | in rural areas. |

The system 100 can then render a user interface with the determined personality type and/or identity tokens for presentation to the user. In one embodiment, the identity tracking service or client enables the user to configure parameters related to the creation and/or distribution of the identity tokens. For example, the user may configure the following parameters:
1. Services or applications where the identity tokens should be published (e.g., Facebook, Linkedin, Skype, etc.).
2. Preferred style for the identity tokens (e.g., graphical style, audio style, etc.) to be used in various services or applications (e.g., the user can choose between serious or more playful graphic language, depending on the service the user prefers the identity tokens to be featured in).
3. Pace of updating the identity token in the service or application (e.g., as a dynamic alternative, the user could opt for daily updates of the user's behavioral or personality profile, based on the primary activities of a single day; or as a more enduring alternative, the user could choose to accept changes to the behavioral or personality profile on a yearly or longer basis—in this case, the identity tokens would be a semi permanent representation of some fundamental characteristics of the user).
4. Privacy settings of the identity tokens (e.g., is the profile visible to all service users versus should access to the identity tokens be limited to circle of close friends?).

Once the user has configured the values using the identity tracking service, the system 100 starts communication with the selected services or applications. In one embodiment, the type of identity token to be displayed in any given service or application is communicated, as well as accompanying parameters, such as privacy settings. In addition, the identity tracking service sends updates to the selected services and/or applications when the identity tokens needs to be change (e.g., based on the frequency configured by the user). Similarly, in one embodiment, the services and/or applications can send information back to the identity tracking service or client on a regular basis. As discussed above, this information may include, for instance, statistics pertaining to the popularity of the identity tokens. For example, the user might want to track the frequency at which other service users are commenting on the user's identity tokens.

Although the embodiments of the use case described above are based on location data, it is contemplated that other contextual data types or modalities can be used to determine personality or behavioral characteristics for generating the identity tokens. Examples of other contextual data types or modalities include, but are not limited to:
1. Devices in proximity to the user device: e.g., Bluetooth MAC ID of a nearby device can be used to deduce the type of device (e.g., whether the device is a personal computer, mobile phone, printer, etc.). Overall, the pattern of encountering various kinds of devices across different contexts can reveal certain aspects of the identity of the user. For instance, the user can be expected to be working in the high tech field if there are several phones and personal computers detected in the user's proximity during office hours.
2. Audio data: sampling with the help of a device's microphone can reveal what types of emotions the user prefers to express across different kinds of situations or contexts. In one embodiment, the ability to track an emotional range has implications on the ease at which the personality type or characteristics of a user can be derived.
3. Mobile phone logging: preference for particular types of applications can be used as a basis for determining personality categories. For example, the system 100 can use application use data to determine whether a user is a gamer, a camera user, a texter, etc.

As shown in FIG. 1, the system 100 comprises one or more user equipment (UEs) 101a-101n (also collectively referred to as UEs 101) having connectivity to a user identity platform 103 via a communication network 105. In addition or alternatively, the UEs 101 may include respective identity managers 107a-107n (also collectively referred to as identity managers 107) to perform all or a portion of the functions of the user identity platform 103 with respect to building, using, accessing, etc. context-based identity tokens as discussed with respect to the various embodiments described herein. As depicted in FIG. 1, the UEs 101 may include or have access to an application 109 (or applications 109), which may consist of client programs, services, or the like that may utilize the service platform 111, the services/applications 113a-113m (also collectively referred to as services/applications 113), the content providers 115a-115k (also collectively referred to as content providers 115), or other services, applications, content, etc. available over the communication network 105. As users access any of the applications 109, the service platform 111, the services/applications 113, and/or the content providers 115, the user identity platform 103 and/or identity manager 107 can collect contextual data associated with the UE 101, use of applications 109, the services 113, the content providers 115, etc. for storage in the profile database 117.

In one embodiment, the profile database 117 stores the contextual data as part of user profile information. In some embodiments, context-based user profile can also provide for a layered structure to control privacy and/or security of the profile. For example, user contexts and associated user preferences or settings can be grouped according to different classes that are associated with different levels of privacy and/or security controls. In this way, a user can grant access to various portions of the user profile on a class-by-class level to advantageously enable more efficient designation and control of privacy and/or security of user contexts, particularly as the number of contexts embedded in the user profile increases.

In yet another embodiment, the context-based user profile supports profile adaption and extensibility for applicability to a wide range of applications and/or services. For example, the contexts, applications, services, etc. may express context information according to different ontologies or vocabularies. The system 100 can translate the information among the various contexts, applications, services, etc. so that like information can be identified and processed. In this way, the system 100 need not manage or impose a system-wide ontology or vocabulary. As used herein, an ontology refers, for instance, to a defined schema for specifying the various context information, parameters, controls, structures, rules, mechanisms, and the like for expressing profile information.

In another embodiment, the system 100 makes the user profile available to applications, services, content providers, etc. through APIs or other interfaces so that context-based user preferences can be taken into account when performing functions, configuring settings, delivering services, providing content, etc. In this way, the advanced context-based user profile can be uniquely associated with a user to express preferences, settings, etc. for content, applications, services, and the like consumed, used, or initiated by or on behalf of the user.

In addition, the user identity platform 103 and/or the identity managers 107 can collect contextual data from one or more respective sensors 119a-119n (a sound recorder, light sensor, global positioning system (GPS) device, temperature sensor, motion sensor, accelerometer, and/or any other device that can be used to collect information about surrounding environments associated with the UE 101). The collected contextual data then be used to determine one or more behavioral or personality characteristics for generating the identity tokens.

In one embodiment, the services/applications 113a-113m comprise the server-side components corresponding to the applications 109a-109n operating within the UEs 101. In one embodiment, the service platform 111, the services/applications 113a-113m, the applications 109a-109n, or a combination thereof have access to, provide, deliver, etc. one or more items associated with the content providers 115a-115k. In other words, content and/or items are delivered from the content providers 115a-115k to the applications 109a-109n or the UEs 101 through the service platform 111 and/or the services/applications 113a-113n. In one embodiment, the delivery and/or execution of these content, services, applications, etc. are collected as contextual data associated with the UE 101, a user of the UE 101, other UEs 101, other users, or a combination thereof.

In one embodiment, contextual data maybe collected as one or more contextual records. By way of example, a context record includes, at least in part, all context data and interaction data (e.g., date, time of day, location, activity, etc.) collected at a specific time. In one embodiment, the interaction data may serve as contextual parameters for stratifying the contextual data for processing. For example, contextual records maybe stratified by time of day, so that personality characteristics derived from the stratified data can also be correlated with the time of day or any other selected contextual parameter. Accordingly, the system 100 can also generate identity tokens to reflect the specific contextual parameter (e.g., one identity token reflecting a different personality characteristic associated with the morning, and another identity token associated with a user's personality at night time).

By way of example, the context record may contain or describe several contexts wherein each context is a subset of the context data included in the context record. For example, given a context record including a time, context data, and interaction data, e.g., [time=t1, Context Data=<(Work Day), (Evening), (High Speed), (High Audio Level)>, Interaction=Play Games], various combinations or permutations of the context data can yield various contexts such as: (1) <(Evening)>, (2) <High Speed>, (3) <(Work Day), (Evening)>, etc. Further, in one embodiment, the contexts from the context data may be arranged according to the timestamp of each record and may be placed into context groups based on, for instance, the similarity of the contexts (e.g., whether the contexts associated with the same location, environmental condition, user activity, etc.). For example, a context can be any subset of the context data arranged in any combination, which can then be organized as context groups or patterns. The combinations of the contexts with respect to the time stamp may be referred as context patterns, and same or similar context patterns may be grouped into context groups.

The behavior patterns or personality characteristics of the user may be determined based on the association of the context groups (or context patterns) and the interaction data. Generally, the context data is generally continuous over time and is volatile, whereas the interaction data is sparse over time. For example, when both the contexts and the interaction data are organized by timestamps representing different time intervals over a period of time, there may be many instances where there may be some context data but no interaction data corresponding to a certain time stamp because the user generally does not continuously interact with the UE 101. Thus, the system 100 determines the time range over which a common context occurs and places the continuously recorded contexts into context groups associated with the common context. In this way, and the system 100 can associate the contexts (e.g., according to the time ranges represented by the context records in the context groups) with the interaction data, instead of associating individual context records, for determining behavior patterns.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the user identity platform 103, and the identity manager 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the identity manager 107 and the user identity platform 103 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

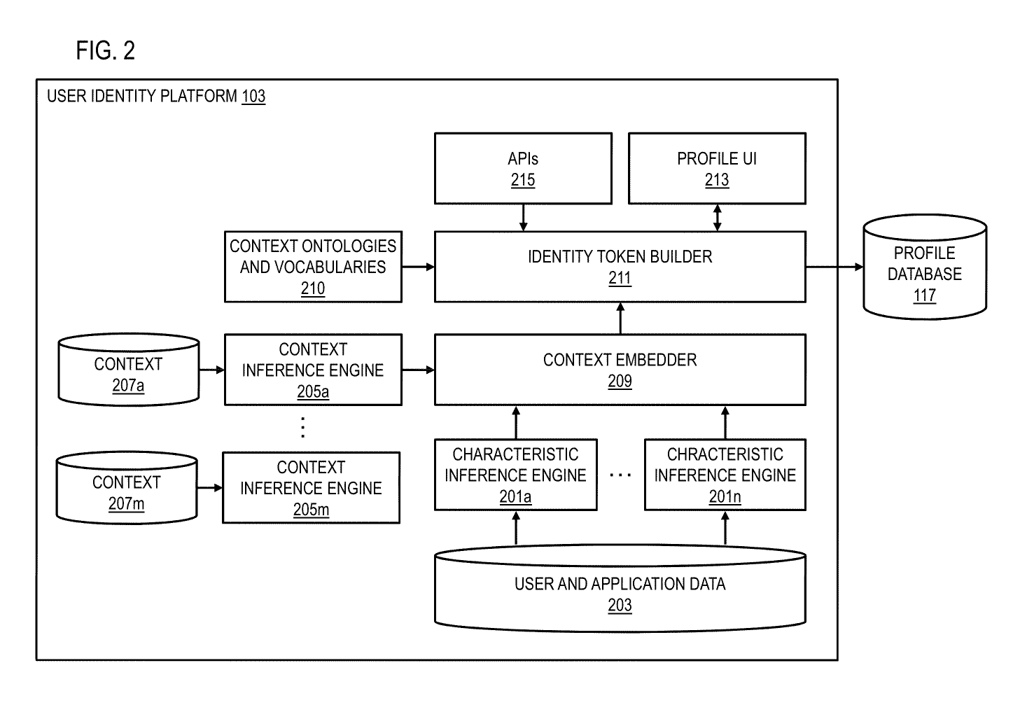

FIG. 2 is a diagram of the components of a user identity platform, according to one embodiment. By way of example, the user identity platform 103 includes one or more components for providing identity expression in digital media. It is contemplated that the functions of these components may be combined in one or more components or performed by other components of equivalent functionality. In this embodiment, the user identity platform 103 executes at least one algorithm for performing and/or coordinating the functions related to generating identity tokens based on contextual data for identity expression in services and/or applications. As noted previously, it is contemplated that all or a portion of the functions of the identity platform 103 may be performed by the identity manager 107 executing on the UE 101. In one embodiment, the determination of whether to perform a process at the identity platform 103 or the identity manager 107 depends on user privacy settings or configuration. For example, because the identity manager 107 is local to the UE 101, contextual data need not be transmitted from the UE 101 if the identity manager 107 performs all or a portion of the identity token generation process. However, the privacy concerns can, in some cases, be balanced against the greater resources (e.g., computational resources, memory resources, etc.) available at the identity platform 103.

As shown, the identity platform 103 includes one or more user Personality Inference Engines (PIEs) 201a-201n (also collectively referred as PIEs 201) that use, for instance, advanced machine learning techniques such as collaborative filtering to process user and application data (e.g., in the user and application database 203) to support determination of user behavior patterns, personality characteristics, contexts, etc. for generating identity tokens. These user behavior or personality characteristicss are then mapped to certain identity tokens for identity expression.

In certain embodiments, there may be several PIEs 201 in a UE 101 with each PIE 201 concentrating on one or more particular personality characteristic or data modality. In other words, each PIE 201 may include specific algorithms and or access specific data to infer user characteristic information from a particular type or source of user behaviors, personalities, or contexts. For example, one PIE 201 may concentrate on making inferences about personality characteristics associated location or mobility data, whereas another PIE 201 may concentrate on making inferences about personality characteristics associated with sports activities.

The user identity platform 103 also includes one or more Context Inference Engines (CIEs) 205a-205m (also collectively referred to as CIEs 205) that function similarly to the PIEs 201 except that the data being used are current context information that depict, for instance, user, system, and/or environmental contexts or context information. In one embodiment, the CIE 205 uses respective primary context sources 207a-207m (also collectively referred to as context sources 207) and related inferences to determine latent contexts or personality characteristics associated with a UE 101 or an associated user. For example, the CIE 205 can combine several sources or types of context information to form a higher level hypothesis with respect to what contexts or characteristics to associate with the user. Like, the PIEs 201, the user identity platform 103 can include one or more CIEs 205 that concentrate on generating specific types of contexts or context inferences.

In one embodiment, the context embedder 209 then combines input from the PIEs 201 and the CIEs 205s and integrates the data in a user personality profile according to certain integration rules. By way of example, the integration rules generally specify what data modalities or contextual data types are of relevance to a given service or application. The rules may also be used to stratify the contextual data based on one or more contextual parameters (e.g., location, time, activity, etc.). inferred contexts and associated user preferences that can be used to pre-fill or otherwise populate context fields in the context-based user profile to describe a user's personality characteristics.

In one embodiment, the context embedder 209 chooses an appropriate template or rule based on input from the PIEs 201 and integrates/fills the selected template with appropriate context data if available to determine user personality characteristics. The context embedder 209 then feeds the information to the identity token builder (ITB) 211. It is noted that in one embodiment, the PIEs 201, the CIEs 205, and the context embedder 209 can be a single integrated entity and may rely on a single database (e.g., a single database combining, for instance, data from the user and application data database 203 and context sources 207). The separate modules are shown in FIG. 1 as an illustration of one possible embodiment.

The ITB 211 then generates one or more identity tokens based on the personality characteristics in the profile by the PIEs 201, the CIEs 205, and the context embedder 209. In one embodiment, the user identity platform 103 uses an XML based profile that enables efficient processing. As previously noted, it is contemplated that any other data format or structure may be used. In one embodiment, the context ontologies and vocabulary definitions (VOCs) module 210 provides definitions and translation of vocabularies used by the different PIEs 201 and CIEs 205 and is used in resolving name conflicts of the various embedded contexts of the personality characteristics profile and the various context related inputs (e.g., manual inputs from the profile user interface (UI) 213). In one embodiment, the profile UI 213 can be part of client applications (e.g., applications 109) or a UI application on its own. The profile UI 213 is used to manually enter user data that is not or cannot be inferred by the PIEs 201 and/or the CIEs 205. By way of example, the profile UI 213 is also used to edit or confirm profile data and identity tokens as well as change privacy settings and levels.

Once the identity tokens are generated, the user identity platform 103 can store the identity tokens locally at the UE 101 or remotely over the communication network 105 (e.g., the profile database 117). The identity tokens are then made accessible or otherwise usable by various applications and services (e.g., applications 109, service platform 111, services/applications 113, etc.). In one embodiment, communications with the applications and/or services are by way of the application programming interfaces (APIs) 215.

In one embodiment, the identity tokens can include any digital media representative of the user's identity (e.g., graphics, audio, text, multimedia, etc.). The identity tokens are generated on the client (e.g., using the identity manager 107) and/or remotely on the server side (e.g., using the user identity platform 103). In some embodiments, generating an identity token includes selecting media representative of the personality characteristics of the user and compositing the media. As previously noted, the identity tokens can be determined based on specific data modalities or types of the contextual data that is most relevant to a particular service or application. In another embodiment, multiple identity tokens may be generated for a given service or application for use under different contexts or situations (e.g., while at work, during certain hours, while performing a particular activity, etc.). In addition, the ITB 211 may also generate the identity tokens based on selected themes that reflect user interests or other contexts (e.g., holidays, seasons, etc.).

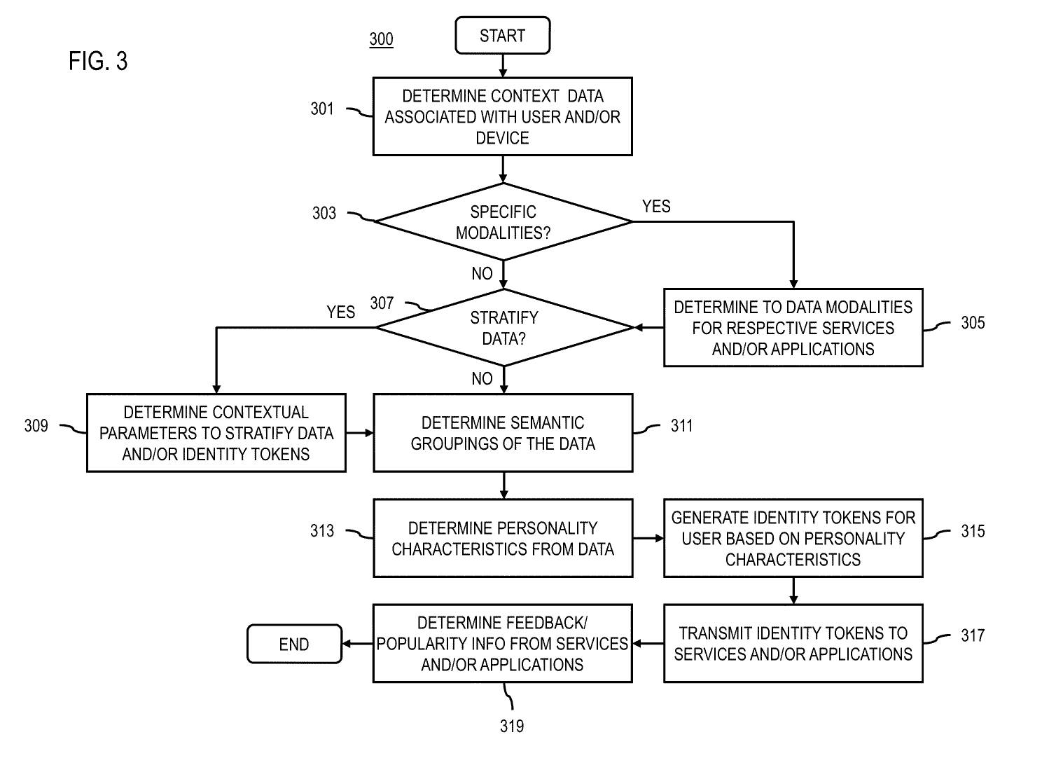

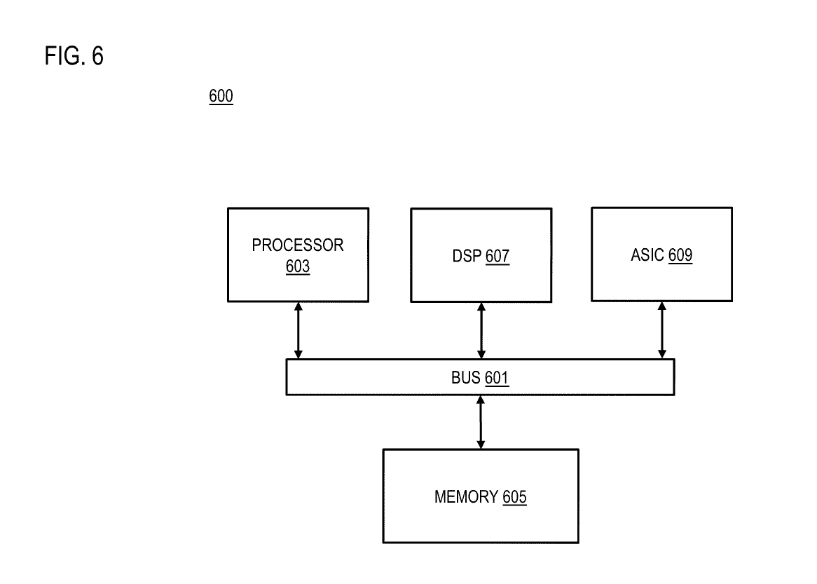

FIG. 3 is a flowchart of a process for segmenting a user profile into one or more classes, according to one embodiment. In one embodiment, the user identity platform 103 performs the process 300 and is implemented in, for instance, a chip set including a processor and a memory as shown in FIG. 6. In addition or alternatively, the identity manager 107 may perform all or a portion of the process 300. In step 301, the user identity platform 103 determines contextual data associated with a user, one or more devices (e.g., UEs 101) associated with the user, or a combination thereof. As discussed previously, the contextual data includes, but are limited, mobility data, location data, application usage data, sensor data, or a combination thereof. In one embodiment, the user identity platform 103 determines the contextual data over one or more time periods specified by the user, a service, and/or an application. For example, a shorter collection time period enables the user identity platform 103 to capture more transient personality characteristics, whereas longer collection time periods enable the user identity platform 103 to determine more fundamental characteristics of the user. It is contemplated that, in one embodiment, the one or more time periods varies, at least in part, from an at least substantially real-time period (e.g., minutes, hours, days) to an extended time period (e.g., weeks, months, years).

In some embodiments, the user identity platform 103 determines whether specific or certain data modalities of the contextual data are to be processed for generating an identity token (step 303). For example, specific modalities or types of contextual data may be configured by a user, determined by a user's privacy settings, or specified by the service or application that is to receive the identity token. In this case, the user identity platform 103 determines one or more modalities of the contextual data associated with respective ones of the one or more services, the one or more applications, or a combination thereof (step 305). For example, in one embodiment, the user identity platform 103 does not expose any data modality or type that is not requested or authorized for access by the service or application. In addition, the selection of specific modalities enables the user identity platform 103 to customize the identity token for a particular service or application.

In step 307, the user identity platform 103 determines whether to stratify the contextual data for processing. If the data are to be stratified, the user identity platform 103 causes, at least in part, a stratification of the contextual data into one or more subsets based, at least in part, on one or more contextual parameters. In one embodiment, the one or more contextual parameters include, at least in part, a location parameter, a temporal parameter, an activity parameter, or a combination thereof. For example, the data can be stratified based on location, time, activity, etc. (step 309). In step 311, the user identity platform 101 processes and/or facilitates a processing of the contextual data (e.g., either stratified or unstratified) to determine one or more semantic groupings of one or more portions of the contextual data. The semantic groupings, for instance, or determined based on processing to infer meaning from the contextual data so that data related or otherwise associated with a contexts of similar meanings are grouped together.

The user identity platform 103 then processes and/or facilitates a processing of the contextual data (e.g., the semantically grouped contextual data) associated with a user, one or more devices associated with the user, or a combination thereof to determine one more or user personality characteristics (step 313). The user identity platform 103 then causes, at least in part, a generation of one or more identity tokens based, at least in part, on the one or more user personality characteristics (step 315). As previously described, the one or more identity tokens represent the user in one or more services, one or more applications, or a combination thereof. In some embodiments, the user identity platform 103 can also cause, at least in part, a rendering of at least one user interface for at least one of: (1) presenting the one or more personality characteristics for confirmation or modification; (2) presenting the one or more identity tokens for confirmation or modification; (3) presenting the one or more services, the one or more applications, or a combination thereof for confirmation or modification; (4) determining one or more privacy settings associated with the contextual data, the one or more identity tokens, or a combination thereof; and the like.

Next, the user identity platform 103 causes, at least in part, a transmission of the one or more identity tokens to one or more services or applications for use in representing the user. By way of example, the transmission may be performed directly via an application programming interface, transmitted via one or more communication protocols (e.g., emails, instant messaging, text messaging, etc.), or conveyed in any other way from the user identity platform 103 to the appropriate applications or services. The user identity platform 103 can also determine popularity information of the one or more identity tokens with respect to the one or more services, the one or more applications, or a combination thereof (step 319). In one embodiment, the popularity information can be presented to the user to aid in determining what identity tokens to generate or select for use.

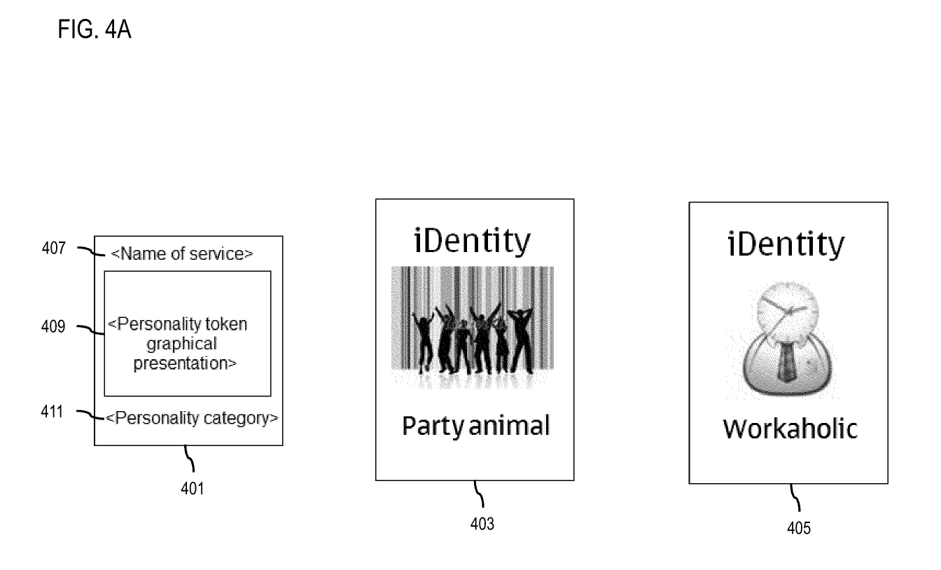

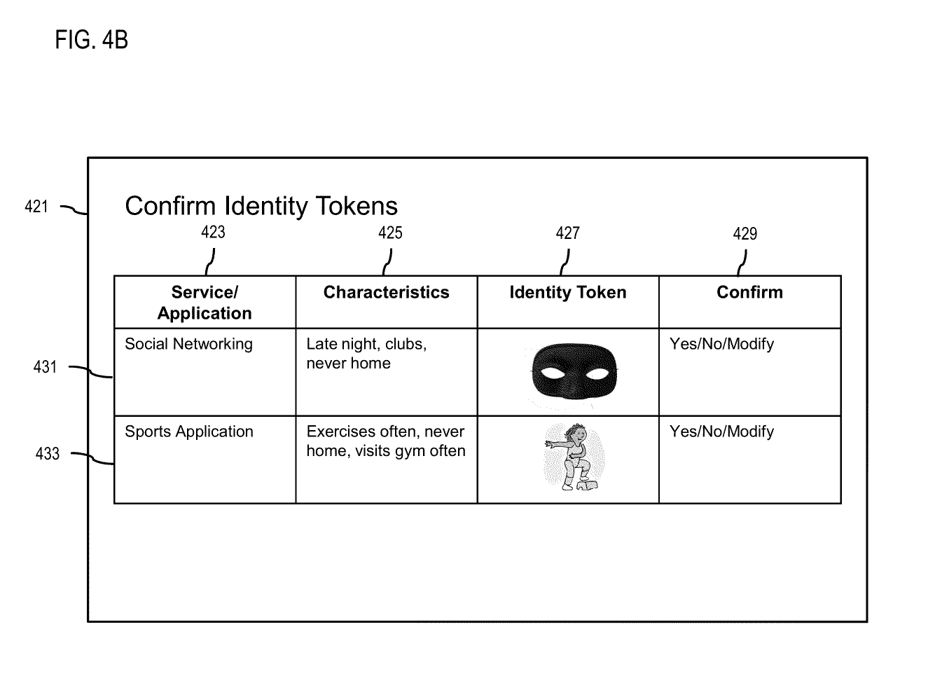

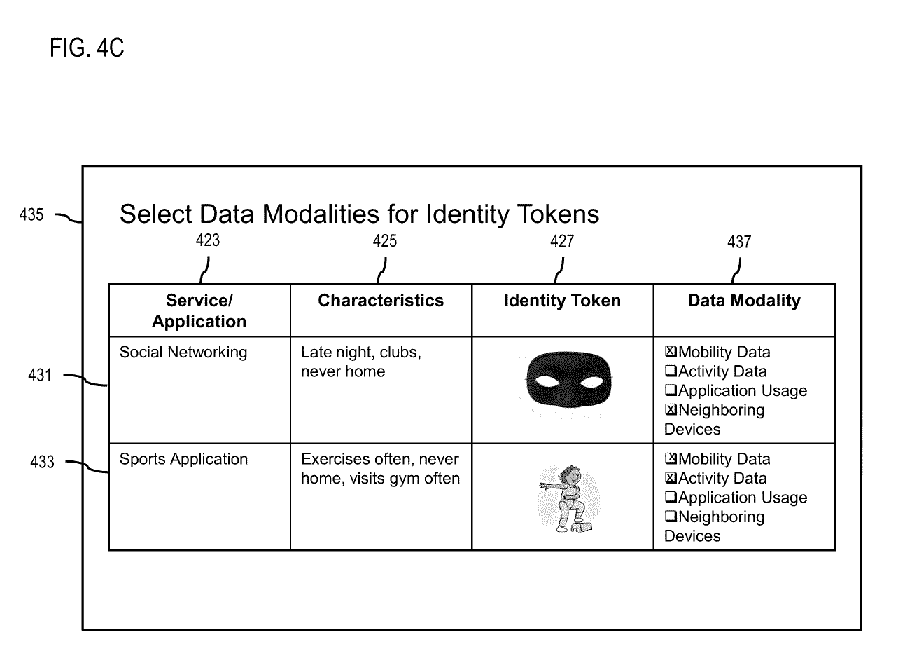

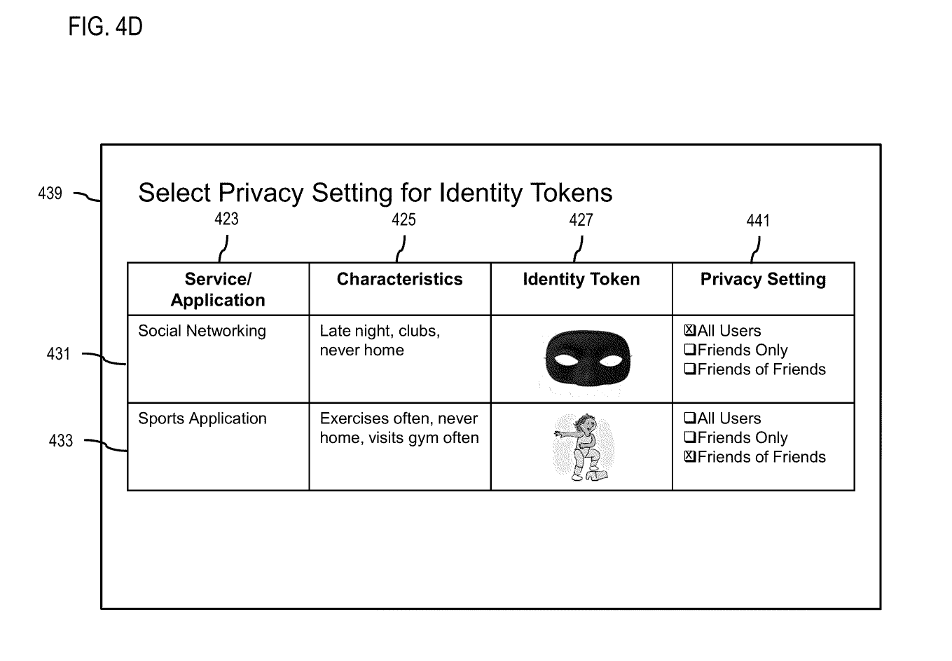

FIGS. 4A-4D are diagrams of user interfaces utilized in the processes of FIGS. 1-3, according to various embodiments. FIG. 4A depicts examples of identity tokens generated using the various embodiments described herein. More specifically, three identity tokens 401-405 are depicted. Identity token 401 is a wireframe representation of a structure of an identity token. In the example of FIG. 4A, identity token 401 identifies a name 407 of the service or application to which the token 401 applies. The segment 409 is the graphical representation of the personality characteristics determined about a user and, typically, is the most recognizable part of the identity token 401. Then, segment 411 of the identity token 401 presents a description of the main one or more personality characteristics that represent the user.

Identity tokens 403 and 405 are examples of identity tokens generated for specific personality categories. For example, identity token 403 is generated for a user whose personality characteristics indicate that the user is a “Party Animal”. The identity token 403 further provides a graphical representation of the personality characteristic and specifies that the service using this token is the “iDentity” service. Identity token 405 is another example identity token generated for a user whose personality characteristics indicate that the user is a “Workaholic”. The identity token 405 provides a graphical representation of “Workaholic” and also indicates that the token is for use in the “iDentity” service or application.

FIG. 4B depicts a user interface 421 for confirming identity tokens generated according to the various embodiment described herein. User interface 421 provides a table with a column 423 for identifying a service or application to which an identity token applies, a column 425 to list the characteristics determined about a user with respect to the service or application, a column 427 for presenting the identity token, and a column 429 for the user to confirm the identity token. For example, the confirmation column 429 enables the user to confirm (e.g., “Yes”), reject (e.g., “No”), or modify (e.g., “Modify”) the presented identity token. In addition, the user interface 421 provides rows corresponding to the various for which identity tokens have been generated. In this example, there are two rows: a row 431 presenting identity token information for a social networking service, and a row 433 presenting identity token information for a sports application. Through the user interface 421, the user can confirm the identity tokens for any number of services.

FIG. 4C depicts a user interface 435 for selecting the data modalities that are used for generating an identity token. As shown, the user interface 435 contains similar elements to the user interface 431 described above with the exception that the confirmation column 429 is replaced with a data modality column 437. In one embodiment, the data modality column 437 lists the available data modalities and enables the user to choose from among the listed modalities those that are to be used for generating a particular identity token for a particular service. In this example, the user has selected to use mobility data and neighboring devices data to generate an identity for the social networking service 431; and the user has selected to use mobility data and activity data to generate an identity token for the sports application 433.

FIG. 4D depicts a user interface 439 for specifying privacy settings for generated identity tokens. As shown, the user interface 439 contains similar elements to the user interface 431 described above with the exception that the confirmation column 429 is replaced with a privacy setting column 441. In one embodiment, the privacy setting column 441 enables the user to select whether the generated identity token is to be visible to “All Users”, to “Friends Only”, or to “Friends of Friends”. In this example, the user has selected to make the identity token for the social networking service to be available to all users, whereas for the sports application 433, the user has selected to make the identity token visible only to friends of friends.

The processes described herein for providing identity expression in media may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

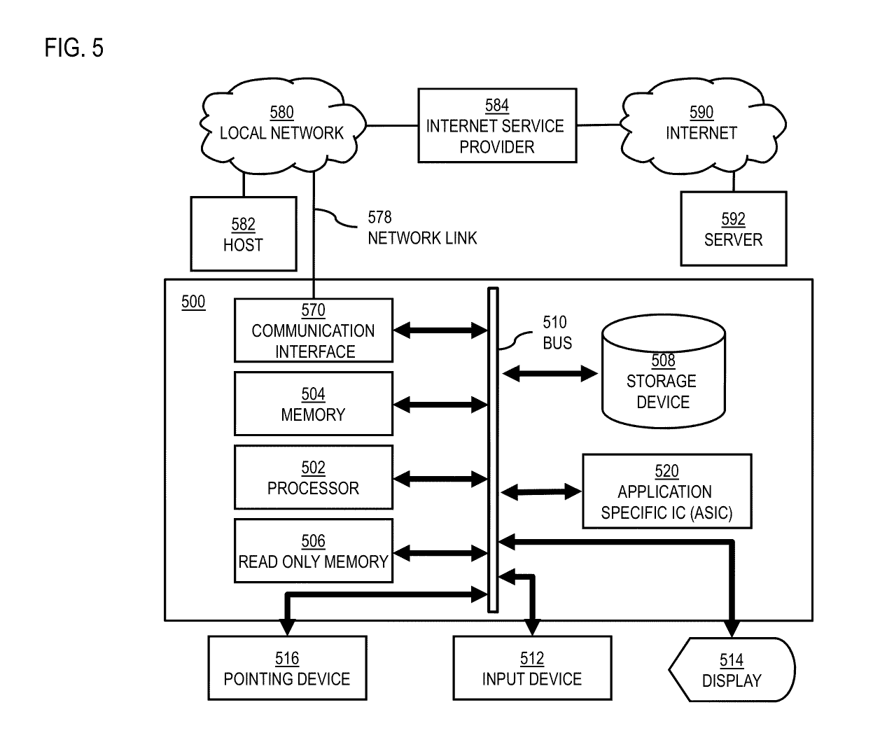

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to provide identity expression in media as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of providing identity expression in media.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to providing identity expression in media. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for providing identity expression in media. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for providing identity expression in media, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for providing identity expression in media to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to provide identity expression in media as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of providing identity expression in media.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to provide identity expression in media. The memory 605 also stores the data associated with or generated by the execution of the inventive steps.

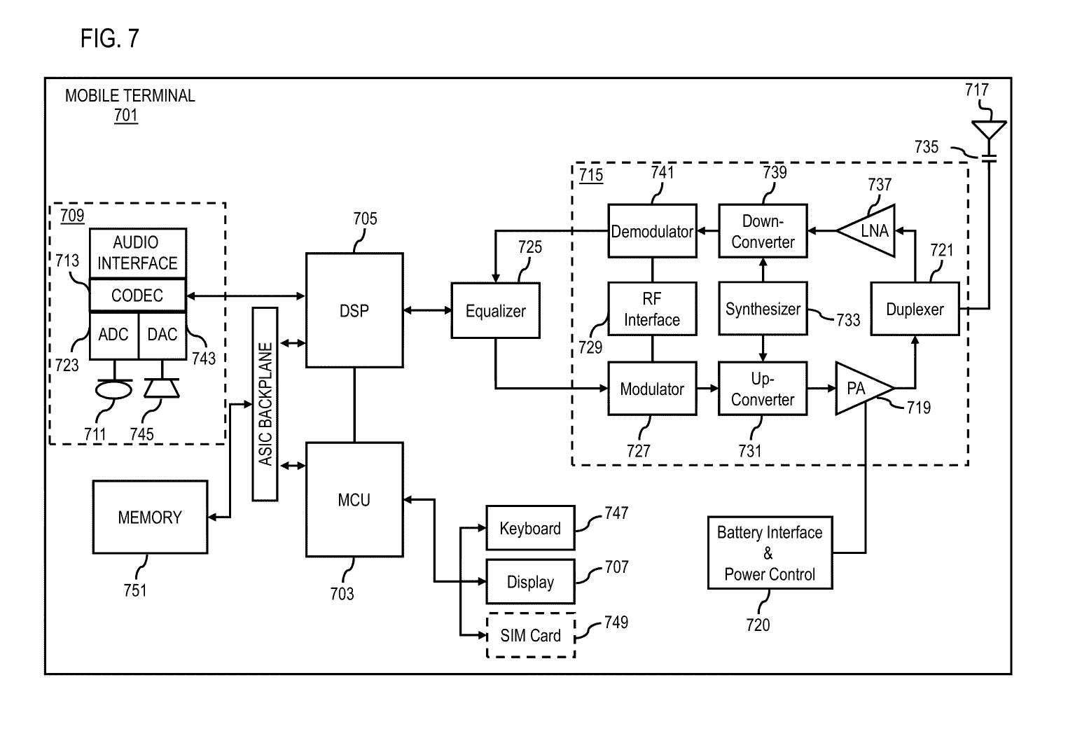

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of providing identity expression in media. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of providing identity expression in media. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to provide identity expression in media. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a processing of contextual data associated with a user, one or more devices associated with the user, or a combination thereof to determine one more or user personality characteristics; and
a generation of one or more identity tokens based, at least in part, on the one or more user personality characteristics,
wherein the one or more identity tokens represent the user in one or more services, one or more applications, or a combination thereof.

2. A method of claim 1, wherein the (1) data and/or (2) information and/or (3) at least one signal are further based, at least in part, on the following:
at least one determination of one or more modalities of the contextual data associated with respective ones of the one or more services, the one or more applications, or a combination thereof;
at least one determination of the one or more personality characteristics based, at least in part, on the one or more modalities for the respective ones of the one or more services, the one or more applications, or a combination thereof; and
at least one determination to cause, at least in part, the generation of the one or more identity tokens for the respective ones of the one or more services, the one or more applications, or a combination thereof.

3. A method of claim 1, wherein the (1) data and/or (2) information and/or (3) at least one signal are further based, at least in part, on the following:
at least one determination of the contextual data over one or more time periods; and
at least one determination to cause, at least in part, the generation of the one or more identity tokens is based, at least at least in part, on the one or more time periods.

4. A method of claim 3, wherein the one or more time periods varies, at least in part, from an at least substantially real-time period to an extended time period.

5. A method of claim 1, wherein the (1) data and/or (2) information and/or (3) at least one signal are further based, at least in part, on the following:
a processing of the contextual data to determine one or more semantic groupings of one or more portions of the contextual data; and
at least one determination of the one or more personality characteristics, the one or more identity tokens, or a combination thereof based, at least in part, on the one or more semantic groupings.

6. A method of claim 1, wherein the (1) data and/or (2) information and/or (3) at least one signal are further based, at least in part, on the following:
a stratification of the contextual data into one or more subsets based, at least in part, on one or more contextual parameters; and
at least one determination of the one or more personality characteristics, the one or more identity tokens, or a combination thereof for respective ones of the one or more subsets.

7. A method of claim 6, wherein the one or more contextual parameters include, at least in part, a location parameter, a temporal parameter, an activity parameter, or a combination thereof.

8. A method of claim 1, wherein the (1) data and/or (2) information and/or (3) at least one signal are further based, at least in part, on the following:
popularity information of the one or more identity tokens with respect to the one or more services, the one or more applications, or a combination thereof.

9. A method of claim 1, wherein the (1) data and/or (2) information and/or (3) at least one signal are further based, at least in part, on the following:
a rendering of at least one user interface for at least one of:
presenting the one or more personality characteristics for confirmation or modification;
presenting the one or more identity tokens for confirmation or modification;
presenting the one or more services, the one or more applications, or a combination thereof for confirmation or modification; and
determining one or more privacy settings associated with the contextual data, the one or more identity tokens, or a combination thereof.

10. A method of claim 1, wherein the one or more identity tokens include, at least in part, a graphical identity token, an audio-based identity token, a text-based identity token, a multimedia identity token, or a combination thereof.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of contextual data associated with a user, one or more devices associated with the user, or a combination thereof to determine one more or user personality characteristics; and
cause, at least in part, a generation of one or more identity tokens based, at least in part, on the one or more user personality characteristics,
wherein the one or more identity tokens represent the user in one or more services, one or more applications, or a combination thereof.

12. An apparatus of claim 11, wherein the apparatus is further caused to:
determine one or more modalities of the contextual data associated with respective ones of the one or more services, the one or more applications, or a combination thereof;
determine the one or more personality characteristics based, at least in part, on the one or more modalities for the respective ones of the one or more services, the one or more applications, or a combination thereof; and
cause, at least in part, the generation of the one or more identity tokens for the respective ones of the one or more services, the one or more applications, or a combination thereof.

13. An apparatus of claim 11, wherein the apparatus is further caused to:
determine the contextual data over one or more time periods; and
cause, at least in part, the generation of the one or more identity tokens is based, at least at least in part, on the one or more time periods.

14. An apparatus of claim 13, wherein the one or more time periods varies, at least in part, from an at least substantially real-time period to an extended time period.

15. An apparatus of claim 11, wherein the apparatus is further caused to:
process and/or facilitate a processing of the contextual data to determine one or more semantic groupings of one or more portions of the contextual data; and
determine the one or more personality characteristics, the one or more identity tokens, or a combination thereof based, at least in part, on the one or more semantic groupings.

16. An apparatus of claim 11, wherein the apparatus is further caused to:
cause, at least in part, a stratification of the contextual data into one or more subsets based, at least in part, on one or more contextual parameters; and
determine the one or more personality characteristics, the one or more identity tokens, or a combination thereof for respective ones of the one or more subsets.

17. An apparatus of claim 16, wherein the one or more contextual parameters include, at least in part, a location parameter, a temporal parameter, an activity parameter, or a combination thereof.

18. An apparatus of claim 11, wherein the apparatus is further caused to:
determine popularity information of the one or more identity tokens with respect to the one or more services, the one or more applications, or a combination thereof.

19. An apparatus of claim 11, wherein the apparatus is further caused to:
cause, at least in part, a rendering of at least one user interface for at least one of:
presenting the one or more personality characteristics for confirmation or modification;
presenting the one or more identity tokens for confirmation or modification;
presenting the one or more services, the one or more applications, or a combination thereof for confirmation or modification; and
determining one or more privacy settings associated with the contextual data, the one or more identity tokens, or a combination thereof.

20. An apparatus of claim 11, wherein the one or more identity tokens include, at least in part, a graphical identity token, an audio-based identity token, a text-based identity token, a multimedia identity token, or a combination thereof.
